(19) United States
(12) Patent Application Publication
(10) Pub. No.: US 2009/0090223 A1
(43) Pub. Date: Apr. 9, 2009

(54) Quick switch device for connecting driving member to hand tool

(75) Inventor: Arthur Wu, Taichung County (TW)

Correspondence Address: Arthur Wu, P.O. Box 44-2049, Taipei, 10668, TW

(73) Assignee: PROXENE TOOLS CO., LTD

(21) Appl. No.: 11/987,603

(22) Filed: Dec. 3, 2007

(30) Foreign Application Priority Data
Oct. 5, 2007 (TW) 096137551

(51) Int. Cl. B25B 23/16; B25B 13/58

(52) U.S. Cl. 81/124.6

(57) ABSTRACT

A hand tool includes a handle having a first connection end and a second connection end of a driving member is shaped to be engaged with the first connection end by a connection unit which is connected to the second connection end. A control unit is connected to the first connection end and cooperated with the connection unit. A push member is located between the connection unit and the control unit. The push member is moved by the control unit to push the connection unit to disengage from the first connection end. The control unit is operated by a switch unit which is located on a side of the first connection end.

### BACKGROUND OF THE INVENTION

(1) Field of the Invention

The present invention relates to a quick switch device for quickly connecting or disconnecting the driving member to the hand tool.

(2) Description of the Prior Art

A conventional switch device for hand tool is disclosed in U.S. Pat. No. 7,146,886, wherein the handle of the hand tool includes two connection members on two protrusions of the handle and the connection members are connected to two recesses in the driving member. Although the driving member can be quickly connected to the handle, and the driving member is pivotable relative to the handle, the user has to pull the driving member to make sure that the driving member is secured to the handle. Besides, when disconnecting the driving member from the handle, the user has to pull the driving very hard and this is not convenient for the users whose hands might be attached with grease.

The present invention intends to provide a quick switch device that is easily operated to connect or disconnect the driving member to the handle.

### SUMMARY OF THE INVENTION

The present invention relates to a hand tool that comprises a handle having a first connection end and a driving member is pivotably connected to the first connection end by a second connection end thereof. A connection unit is connected to the second connection end and removably connected with the first connection end. A control unit is connected to the first connection end and releases the connection unit when being activated by the user. A push member is located between the connection unit and the control unit. The push member is moved by the control unit to push the connection unit to disengage from the first connection end.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the quick switch device of a hand tool of the present invention;

FIG. 2 shows that the second connection end of the driving member is to be inserted into the space of the first connection end of the handle;

FIG. 3 shows that the connection units on the second connection end are slid along the guide grooves of the protrusions of the first connection end of the handle;

FIG. 4 shows that the second connection end of the driving member is connected to the first connection end of the handle;

FIG. 5 shows that the connection unit is pushed by the push members when the control unit is activated by the switch unit;

FIG. 6 is a perspective view to show quick switch device connecting the driving member to the handle;

FIG. 7 shows another embodiment of the connection unit.

### DETAILED DESCRIPTION OF THE PREFERRED EMBODIMENTS

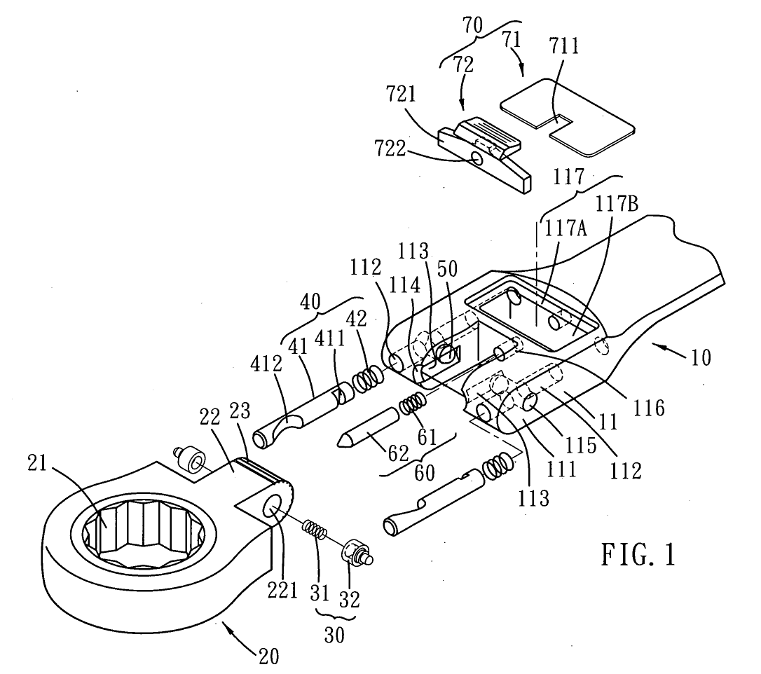

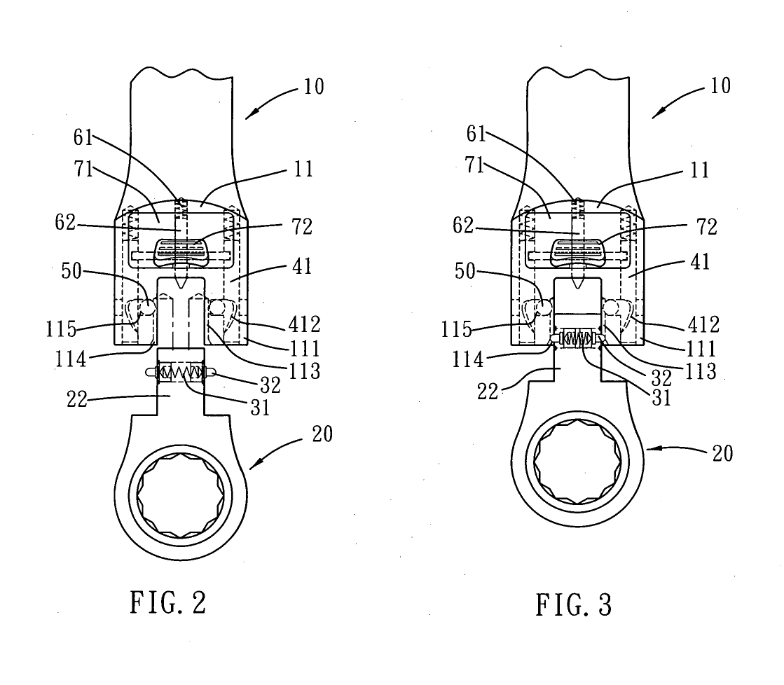

Referring to FIGS. 1 and 2, the hand tool of the present invention comprises a handle 10 having a first connection end 11 which includes two parallel protrusions 111 and a space is defined between the two protrusions 111. Each protrusion 111 includes an axial hole 112 and a control unit 40 is received in each of the axial holes 112. The control unit 40 includes a spring 42 and a rod 41 which is biased by the spring 42. The rod 41 includes a notch 411 and a recess 412 which includes a deeper portion and a shallow portion. A transverse hole 115 is defined transversely through each of the protrusions 111 and communicates with the axial hole 112. Two push members 50 are respectively received in the transverse holes 115 and the push members 50 are two beads in this embodiment. Each of the two protrusions 111 includes a guide groove 113 defined in an inside thereof and the guide groove 113 defines an opening 114 at a distal end of each protrusion 111. A chamber 117 is defined in a side of the first connection end 11 and a switch unit 70 is received in the chamber 117. The chamber 117 communicates with the axial holes 112 and a receiving hole 116 which is defined in an inner end of the space between the two protrusions 111. A positioning unit 60 is engaged with the receiving hole 116 and includes a spring 61 and a pawl 62. The chamber 117 includes a step 117A located at four insides thereof so that a cover 71 is rested on the step 117 and closes the chamber 117. The switch device 70 further includes a button 72 which includes a thumb push portion and a plate 721 is connected to an underside of the thumb push portion by a neck which is movably engaged with a notch 711 defined in a side of the cover 71. The plate 721 includes a hole 722. The pawl 62 extends through the hole 722 to prevent the plate 721 from being disengaged from the chamber 72. The plate 721 are engaged with the notches 411 of the two rods 41 of the control units 40 so that when operating the button 72, the two rods 41 are moved.

A driving member 20 includes a driving port 21 and a second connection end 22 which is shaped to be engaged with the first connection end 11. In this embodiment, the second connection end 22 of the driving member 20 is an insertion which is inserted into the space between the two protrusions 111. The second connection end 22 includes a curved distal end and teeth 23 are defined in the curved distal end. The pawl 62 is engaged with the teeth 23 so as to position the pivotal angle of the driving member 20 relative to the handle 10. A passage 221 is defined through the second connection end 22 and two connection units 30 are engaged with the passage 221. Each connection unit 30 includes a spring 31 and an engaging member 32 which is biased by the spring 31. The engaging member 32 includes a cone-shaped portion which is designed to be engaged with the transverse hole 115.

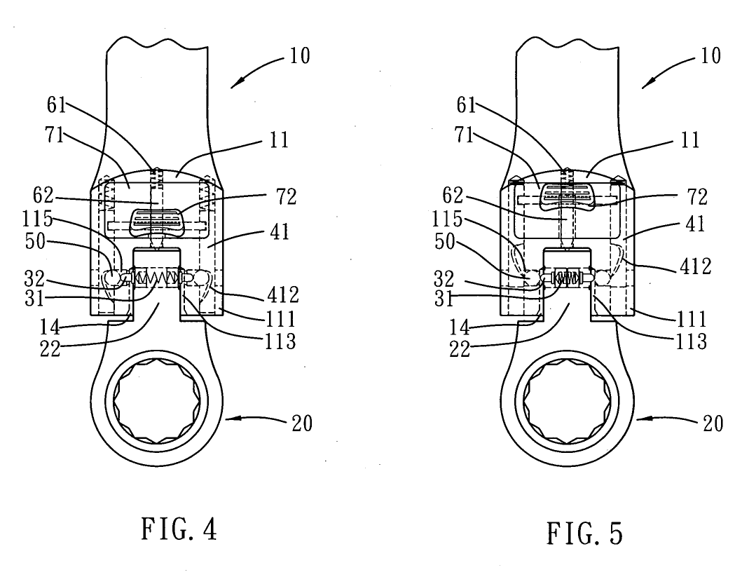

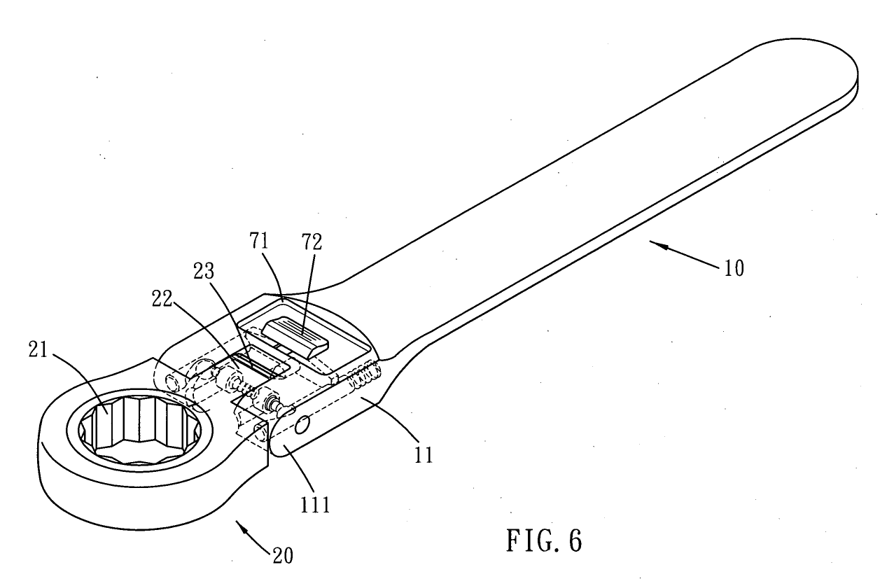

As shown in FIG. 3, when connecting the driving member 20 to the handle 10, the second connection end 22 is inserted into the space between the two protrusions 111 and the engaging members 32 of the connection units 30 are moved along the guide groove 113 and is engaged with the transverse hole 115 of each protrusions 111 to generate a “click” sound so that the user is acknowledged that the driving member 20 is connected with the handle 10 as shown in FIG. 4. In this status, the engaging members 32 push the push members 50 which are then received in the deeper portions of the recesses 412 of the two rods 41 as shown in FIGS. 5 and 6.

When the user pulls the button 72 to pull the two rods 41 away from the driving member 20, the recesses 412 are moved to push the push members 50 to push the two engaging members 32 out from the handle 10.

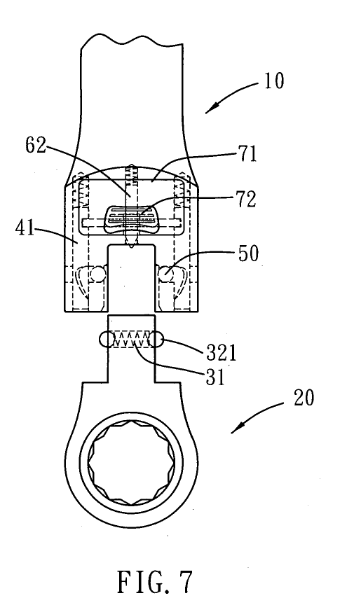

As shown in FIG. 7, the engaging members 321 can also be replaced with two beads 321 which are sized to be engaged with the transverse holes 115.

The driving member 20 is easily connected to the handle 10 simply by inserting the second connection end 22 to the space of the first connection end 11, the engaging members 32 are moved and positioned in the transverse holes 115. The driving member 20 is easily to be separated from the handle 10 by simply operating the button 72.

While we have shown and described the embodiment in accordance with the present invention, it should be clear to those skilled in the art that further embodiments may be made without departing from the scope of the present invention.

What is claimed is:

1. A hand tool comprising:
a handle having a first connection end;
a driving member including a driving port and a second connection end which is shaped to be engaged with the first connection end;
a connection unit connected to the second connection end and removably connected with the first connection end;
a control unit connected to the first connection end and being capable of releasing the connection unit, and
a push member located between the connection unit and the control unit, the push member being moved by the control unit to push the connection unit to disengage from the first connection end.

2. The hand tool as claimed in claim 1, wherein the first connection end includes two parallel protrusions and a space is defined between the two protrusions.

3. The hand tool as claimed in claim 2, wherein the second connection end of the driving member is an insertion which is inserted into the space between the two protrusions, a passage is defined through the second connection end and the connection unit is engaged with the passage.

4. The hand tool as claimed in claim 2, wherein each of the two protrusions includes a guide groove defined in an inside thereof and the guide groove defines an opening at a distal end of each protrusion, a transverse hole is defined transversely through each of the protrusions so that the connection unit is moved along the guide groove and is engaged with the transverse hole of each protrusions.

5. The hand tool as claimed in claim 4, wherein each protrusion includes an axial hole and the control unit is received in the axial hole.

6. The hand tool as claimed in claim 5, wherein the axial holes are in communication with the two transverse holes respectively.

7. The hand tool as claimed in claim 5, wherein a chamber is defined in a side of the first connection end and a switch unit is received in the chamber, the chamber communicates with the axial holes.

8. The hand tool as claimed in claim 7, wherein a receiving hole is defined in an inner end of the space between the two protrusions and communicates with the chamber, a positioning unit is engaged with the receiving hole.

9. The hand tool as claimed in claim 8, wherein the positioning unit includes a spring and a pawl.

10. The hand tool as claimed in claim 5, wherein the control unit includes a spring and a rod.

11. The hand tool as claimed in claim 10, wherein the rod includes a notch and a recess.

12. The hand tool as claimed in claim 1, wherein the push member is a bead.

13. The hand tool as claimed in claim 1, wherein the connection unit includes a spring and an engaging member which is biased by the spring.

14. The hand tool as claimed in claim 3, wherein the second connection end includes a curved distal end and teeth are defined in the curved distal end.

15. The hand tool as claimed in claim 7, wherein the switch unit includes a cover and a button which includes a plate connected to an underside thereof, the plate is engaged with the notch of the rod.

16. The hand tool as claimed in claim 13, wherein the engaging member includes a cone-shaped portion which is engaged with the transverse hole.
